(19) United States
(12) Patent Application Publication
(10) Pub. No.: US 2013/0179601 A1
(43) Pub. Date: Jul. 11, 2013

(54) NODE PROVISIONING OF I/O MODULE HAVING ONE OR MORE I/O DEVICES

(71) Applicants: Toshio Otani, Bellevue, WA (US); Futoshi Haga, Cupertino, CA (US)

(72) Inventors: Toshio Otani, Bellevue, WA (US); Futoshi Haga, Cupertino, CA (US)

(73) Assignee: Hitachi, Ltd., Tokyo (JP)

(21) Appl. No.: 13/347,597

(22) Filed: Jan. 10, 2012

(51) Int. Cl. G06F 3/00

(52) U.S. Cl. 710/12

(57) ABSTRACT

A method for node provisioning in a storage system includes providing an I/O module in the storage system having a network and a storage subsystem, the network connecting the I/O module and the storage subsystem. The I/O module is connected to first and second computer systems and configured to provide virtualized I/O links to the first and second computer systems. A first virtual I/O link associated with a first boot image is mapped to the first computer system, the first boot image being associated with a first I/O device mounted in the I/O module. An I/O switch in the I/O module is caused to connect the first virtual I/O link to the first computer system. The first boot image is suitable for booting a plurality of computer systems connected to the I/O module.

### BACKGROUND OF THE INVENTION

The present invention relates to an I/O device and data image management systems for servers and storage converged systems. A storage converged system is a system that integrates server, storage, and networking management.

Many companies have embraced the virtual machine environment in recent years. Its usage allows physical machines, e.g., servers, to be consolidated into fewer machines and thereby reduce hardware cost. Some estimates that companies often manage more virtual machines than actual physical machines. The number of virtualized physical servers, i.e., physical servers that run virtual machine environment, is expected to increase even more in coming years. The cost of information technology (IT) platform management has been rising with the greater adoption of virtual machine environment since the management of virtual machines tends to be more complicated than physical machines. This is particularly true in a storage converged system that integrates server, storage and network management. One component or device that is often used in a storage converged system is an I/O module that consolidates virtualized network and storage connectivity to service a plurality of computer systems. The I/O module virtualizes server I/O resources.

Another component in the storage converged system is a storage system (also referred to as a “storage subsystem”) that has numerous components operating together to provide fine-tuned and robust data storage. A storage system typically includes one or more storage arrays, a fabric network including a storage network and a LAN, and a plurality of host systems. One type of commonly used storage network is Storage Area Network (SAN).

A host system including an I/O module that virtualizes server I/O resources has become popular recently. The I/O module consolidates and virtualize network and storage connectivity, e.g., in a rack of servers. The I/O module may also be used to increase the capability of virtualized servers by providing virtual machines with high flexibility for connectivity bandwidth and configurable virtual I/O links.

The I/O module typically includes a plurality of I/O device or NICs that are mounted therein. Each I/O device has a network port for communication with the storage subsystem an image database that can store application data and/or boot image. The boot image stored in the I/O device typically is not shared with a plurality of computer systems, which results in inefficient use of storage in the I/O device.

### BRIEF SUMMARY OF THE INVENTION

Embodiments of the present invention relate to an I/O module and data image management systems for a storage converged system. A storage converged system is a system that integrates server, storage, and networking management. In an embodiment, an I/O module is configured to share a boot image stored in an I/O device of the I/O module with a plurality of computer systems. For example, a vI/O mapping for a system boot for a given computer system may be changed as needed by a manager. In another embodiment, a notification method is integrated with a system boot process so that the computer system or an application therein promptly notifies a manager when a boot sequence is completed.

In an embodiment, a method for node provisioning in a storage system includes providing an I/O module in the storage system having a network and a storage subsystem, the network connecting the I/O module and the storage subsystem. The I/O module is connected to first and second computer systems and configured to provide virtualized I/O links to the first and second computer systems. A first virtual I/O link associated with a first boot image is mapped to the first computer system, the first boot image being associated with a first I/O device mounted in the I/O module. An I/O switch in the I/O module is caused to connect the first virtual I/O link to the first computer system. The first boot image is suitable for booting a plurality of computer systems connected to the I/O module. The method further includes mapping the first virtual I/O link associated with the first boot image to the second computer system; and causing the I/O switch in the I/O module to connect the first virtual I/O link to the second computer system.

In another embodiment, an I/O module for providing virtualized I/O links to a plurality of computer systems is disclosed. The I/O module is connected to a storage subsystem via a network. The I/O module includes a plurality of communication ports for connecting with a plurality of computer systems, the computer systems including first and second computer systems that are connected to first and second communication ports, respectively. A first I/O device has an image database and a network port configured to provide a network link to the I/O module, the image database having a first boot image stored therein. The I/O module also includes a plurality of virtual I/O links, at least one virtual link for connecting to the network and at least one for connecting to the image database of the first I/O device; an I/O switch configured to connect the virtual I/O links to the first and second computer systems; and a vI/O device provider configured to communicate with the I/O switch. The I/O device provider is configured to receive a request to map a first virtual I/O link associated with the first boot image to the first computer system, map the first virtual

I/O link associated with the first boot image to the first computer system, and cause an I/O switch to connect the first virtual I/O link to the first computer system.

In yet another embodiment, a storage system includes a storage subsystem, a network, an I/O module connected to the storage subsystem via the network. The I/O module is configured to provide virtualized I/O links to a plurality of computer systems. The I/O module includes a plurality of communication ports for connecting with a plurality of computer systems, the computer systems including first and second computer systems that are connected to first and second communication ports, respectively; first I/O device having an image database and a network port configured to provide a network link to the I/O module, the image database having a first boot image stored therein; a plurality of virtual I/O links, at least one virtual link for connecting to the network and at least one for connecting to the image database of the first I/O device; an I/O switch configured to connect the virtual I/O links to the first and second computer systems; and a vI/O device provider configured to communicate with the I/O switch. The I/O device provider is configured to receive a request to map a first virtual I/O link associated with the first boot image to the first computer system, map the first virtual I/O link associated with the first boot image to the first computer system, and cause an I/O switch to connect the first virtual I/O link to the first computer system. The I/O module further includes a second I/O device having an image database and a network port configured to provide a network link to the I/O module, the image database of the second I/O device having a second boot image stored therein, wherein the I/O module is configured to provide the first and second boot images as being available for the first computer system.

### BRIEF DESCRIPTION OF THE DRAWINGS

FIG. 1 illustrates an exemplary storage converged system.

FIG. 2 illustrates shows a computer system list table.

FIG. 3 illustrates a vI/O list table.

FIG. 4 illustrates an image DB list table.

FIG. 5 illustrates an exemplary process for generating vI/Os in a vI/O list table.

FIGS. 6 and 7 illustrate an exemplary process for vI/O mapping for system boot.

FIGS. 8 and 9 illustrate an exemplary process for performing a system boot.

FIGS. 10 and 11 illustrate an exemplary process for vI/O re-mapping to a computer system.

### DETAILED DESCRIPTION OF THE INVENTION

Embodiments of the present invention relate to an I/O module and data image management systems for a storage converged system. A storage converged system is a system that integrates server, storage, and networking management. In an embodiment, an I/O module is configured to share a boot image stored in an I/O device of the I/O module with a plurality of computer systems. For example, a vI/O mapping for a system boot for a given computer system may be changed as needed by a manager module. In another embodiment, a notification method is integrated with a system boot process so that the computer system or an application therein promptly notifies a manager module when a boot sequence is completed.

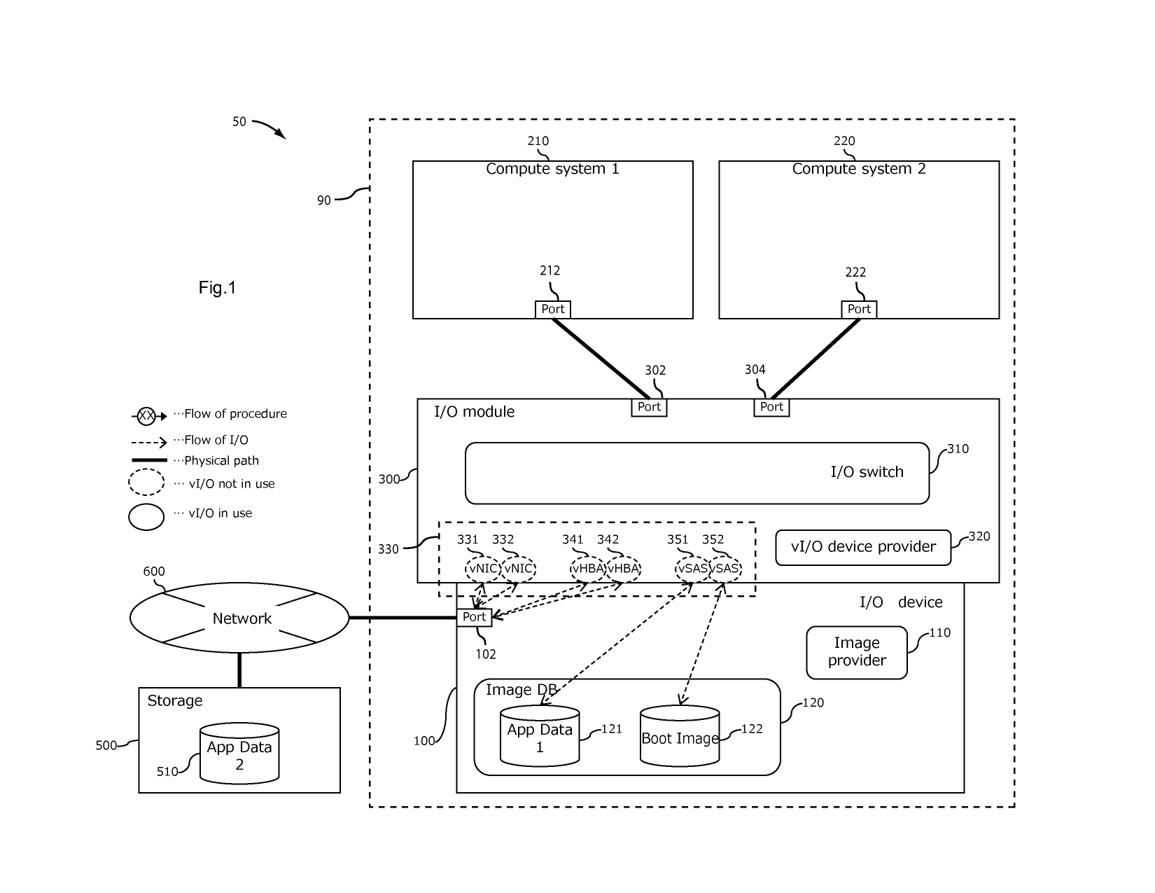

FIG. 1 shows an exemplary storage converged system 50 (also referred to as “a storage system”). Storage system 50 includes a host system 90, a network 600, and a storage subsystem 500. Although a single host system is shown, storage system 50 may have many other host systems that may be of the same or different configuration as host system 90.

In an embodiment, host system 90 is a system that is configured to host OSs, VMs and applications. Host system 90 is configured to access storage subsystem 500 via network 600. Network 600 is any communication network. Network 600 may comprise one or more of the following: Small Computer System Interface (SCSI), Fibre Channel (FC), Enterprise Systems Connection (ESCON), wide area network (WAN), and local area network (LAN).

Storage subsystem 500 includes one or more data storage devices, e.g., to store application data 510 that can be accessed by host systems. In an embodiment, storage subsystem 500 is a disk system that has one or more hard disk drives, optical storage disks, flash memories, or other storage media. The storage subsystem also includes a disk controller (not shown) that controls the access to these storage media.

Referring back to host system 90, it includes a plurality of computer systems 210 and 220, an I/O module 300, and an I/O device 100. Computer systems 210, 220 may be a desktop computer, a laptop computer, a server, or the like. Each computer system includes a communication port to communicate with the I/O module 300. For example, computer system 210 has a port 212 and computer system 220 has a port 222.

I/O module 300 is a server that virtualizes I/O resources. An example of I/O module 300 is a blade server. A typical blade server houses a plurality of blades in which processors, memories, and network interface cards/controllers (or NICs) are mounted. I/O module 300 allows a single NIC to be shared among a plurality of computer systems.

I/O module 300 includes a plurality of communication ports 302 and 304 that are connected to ports 212 and 222, respectively, to communicate with computer systems 210 and 220. In an embodiment, each port of the I/O module is uniquely paired to a port of a computer system, e.g., port 302 is a dedicated to port 212 and port 304 is dedicated to port 222.

I/O module 300 includes an I/O switch 310, a vI/O device provider 320, and a plurality of virtual fabric links (or vI/Os) 330. I/O switch 310 is a switch fabric that provides connection between the ports (e.g., the ports 302 and 304) of the I/O module and virtual fabric links 330. I/O module 330 may be implemented as a hardware device or a software module.

vI/O device provider 320 provides I/O and data image management interfaces to communicate with managers and other systems. vI/O device provider 320 then manages vI/Os 330 connectivity between computer systems and vI/Os according to the requests received. vI/O device provider 320 also controls an image provider associated with each I/O device mounted in I/O module 300 in order to manage the vI/O connectivity. In an embodiment, vI/O device provider 320 is implemented as a software module.

Virtual fabric links (or vI/Os) 330 includes a plurality of vNICs 331 and 332, a plurality of vHBA 341, 342, and a plurality of vSAS 351 and 352, that are linked to resources on NICs mounted in the I/O module. These vI/Os are connected to the ports 302 and 304 within the switch fabric of I/O switch 310 according to the instructions of vI/O device provider 320.

An I/O device 100 may be a network interface card, a network interface controller, a network interface adapter, or the like that connects the I/O module to network 600. In an embodiment, I/O device 100 is a converged network adapter (CNA), also referred to as a converged network interface controller (C-NIC), that combines the functionality of a Host Bus Adaptor (HBA) to a storage area network with a network interface controller for a general-purpose computer network. Although only one I/O device 100 is shown, I/O module 300 typically includes a plurality of I/O devices 100 that are mounted thereon.

I/O device 100 includes a network port 102 and is configured to provide virtual I/O functions or links (vI/Os) to computer systems 210 and 220 via I/O module 300. The vI/Os can provide some PCI functions, for example, virtual NIC (vNIC) 331,332, virtual HBA (vHBA) 341,342 and virtual SAS (vSAS) 351,352, and so on. vNICs provide connectivity to network. vHBAs provide connectivity to storage 500 via network 600. vSAS provides connectivity to data images. Merely as an example, FIG. 1 shows port 102 is connected to vNICs 331 and 332 and vHBAs 341 and 342 in order to provide a communication link to storage subsystem 500.

I/O device 100 also includes an image provider 110 that is configured to manage an image database 120 and the connections between vI/Os and image database 120, e.g., with vSAS 351 and 352. Image database 120 includes an application data 121 and a boot image 122. Application data 121 are data used by applications running on computer systems 210 and 220. Boot image 122 is a computer file containing the contents and structure of a computer storage media that can be used to boot the associated hardware. The boot image usually includes the operating system, utilities and diagnostics, as well as boot and data recovery information. Boot image 122 is configured to be shared by a plurality of computer systems 210 and 220 so that it can be used to boot any computer systems within host system 90 (e.g., computer systems that are connected to I/O module 300). In an embodiment, application data 121 is connected to vSAS 351, and boot image 122 is linked to vSAS 352.

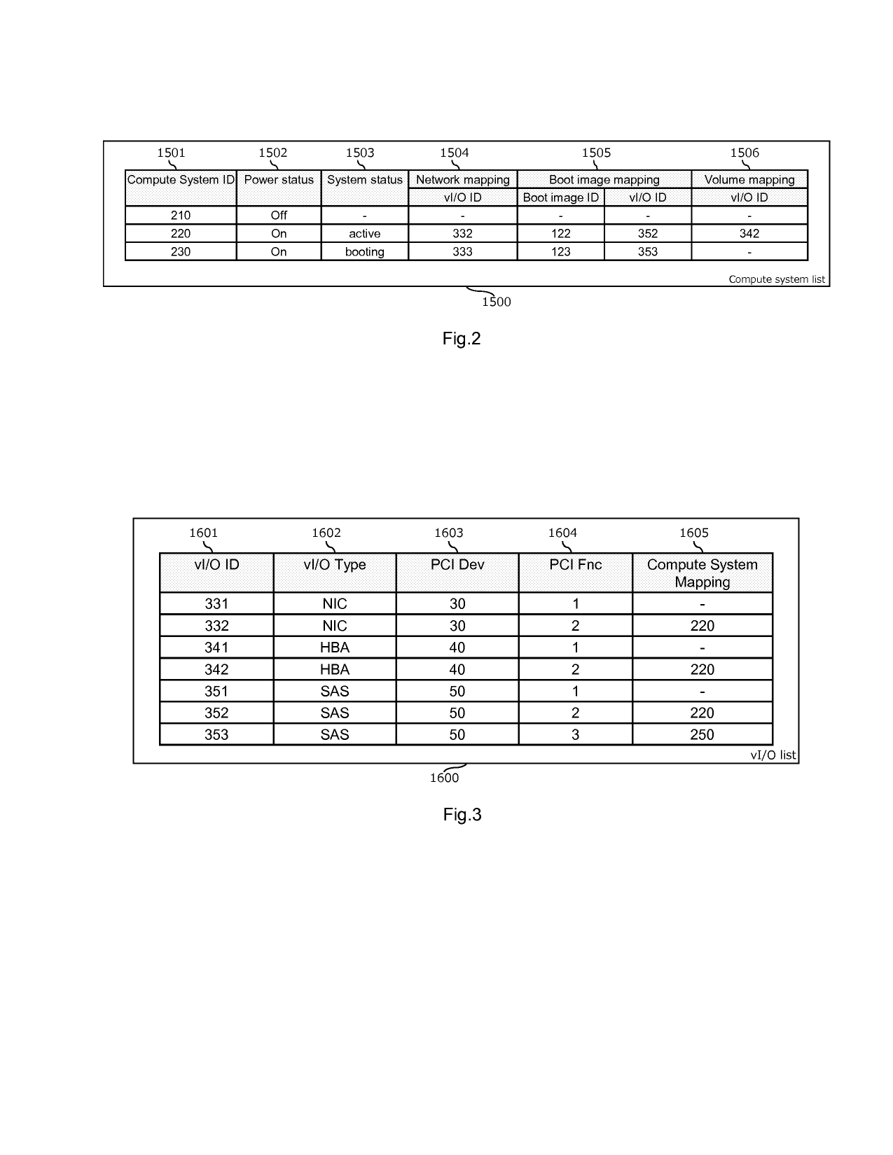

FIG. 2 shows a computer system list table 1500. In an embodiment, vI/O device provider 320 manages table 1500. Table 1500 includes a computer system ID 1501 that uniquely identifies a computer system (e.g., an IP address or other unique name), a power status 1502 that indicates whether a given computer is on or off, a system status 1503 that indicates whether a given computer is inactive, active or booting, a network mapping 1504 that indicates a vI/O ID of a vNIC to which a given computer is mapped, a boot image mapping 1505 that indicates the boot image to which a given computer is mapped, and a volume mapping 1506 that indicates the volume to which a given computer is mapped. Boot image mapping 1505 includes a boot image ID on image data 120 and a vI/O ID of vSASs on I/O device 100 Volume mapping 1506 may indicate a vSAS and/or a vHBA on I/O device 100.

Table 1500 lists three computers, i.e., computer systems 210, 220 and 230. Computer system 230 is not shown in FIG. 1 for simplicity of illustration. A person skilled in the art will appreciate that table 1500 may list many more computers. In an embodiment illustrated, computer system 220 is mapped to a vNIC 332 and vHBA 342 to access application data 510 in storage subsystem 500 via port 102. Computer system 220 is also mapped to vSAS 352 and linked to boot image 122, so that computer system 220 can be boot using boot image 122. Computer system 230 (not shown) is indicated as being boot using boot image 123 (not shown).

In the present embodiment, a plurality of computer systems can mapped to the same boot image so that a single boot image can be used to boot a plurality of computer unlike in the conventional technology. For example, computer systems 210, 220, and 230 can all be configured to be boot using boot image 122, e.g., using a process 1900, as will be explained in more detail later. Accordingly, valuable storage in the I/O device can be reserved for other data files.

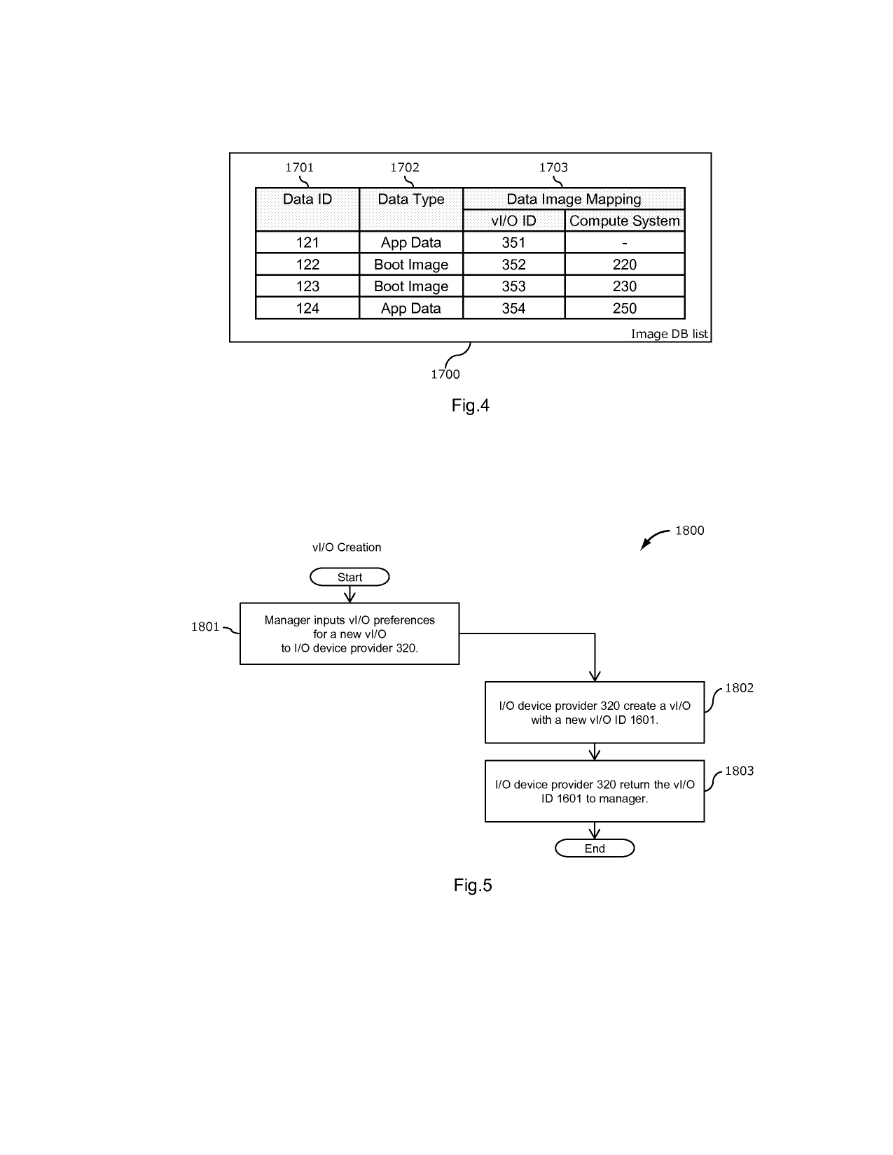

FIG. 3 shows a vI/O list table 1600 that enables managers or other systems to recognize vI/Os on each PCI device (e.g., I/O device 100) mounted in I/O module 300. Table 1600 includes a vI/O ID 1601 that indicates unique identifiers of vI/Os on I/O device 100. A vI/O type 1602 indicates the vI/O type for the vI/O identified in vI/O 1601, e.g., NIC, HBA, and SAS. A computer system mapping 1605 lists the unique identifier of a computer system to which a given vI/O is mapped. Optionally, table 1600 may include a PCI dev 1603 that indicates the PCI device number and a PCI fnc 1604 that indicates a PCI function number of a given vI/O. In an embodiment, vI/O device provider 320 manages table 1600.

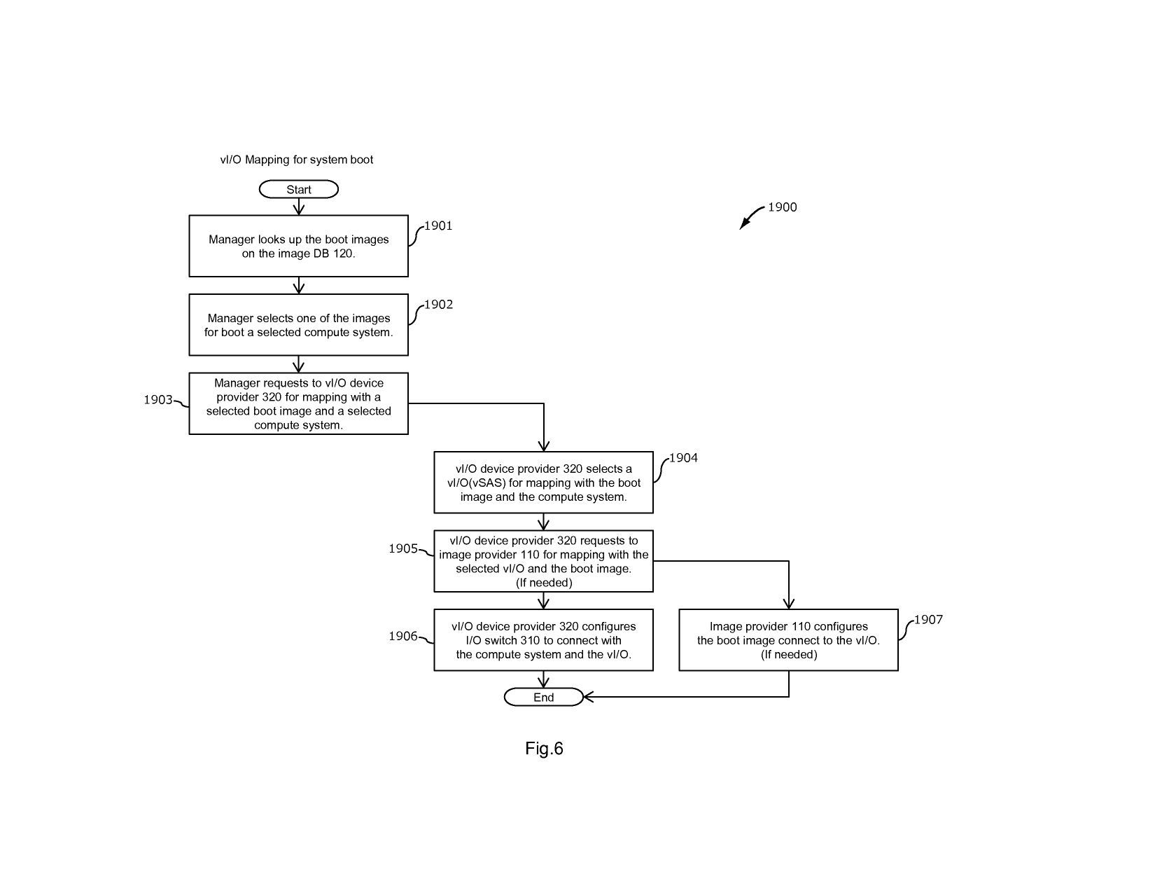

FIG. 4 shows an image DB list table 1700. Table 1700 includes a data ID 1701 that indicates a system unique identifier of a given data image in image database 120, a data type 1702 indicates the data type of the data image listed in data ID 1701. The data type includes a boot image for booting one or more computer systems, application data for use by one or more computer systems, and other types (not shown). Table 1700 also includes a data image mapping 1703 that includes a vI/O ID and a computer system ID, so that the data image identified in data ID 1701 is mapped to a given computer system. Note boot image 122 is mapped to computer system 220 via vSAS 352, which corresponds to the mapping information listed in table 1500. In an embodiment, image provider 110 of I/O device manages table 1700 and cooperates with vI/O device provider 320. Managers and/or other systems use table 1700 to handle I/O requests to and data images.

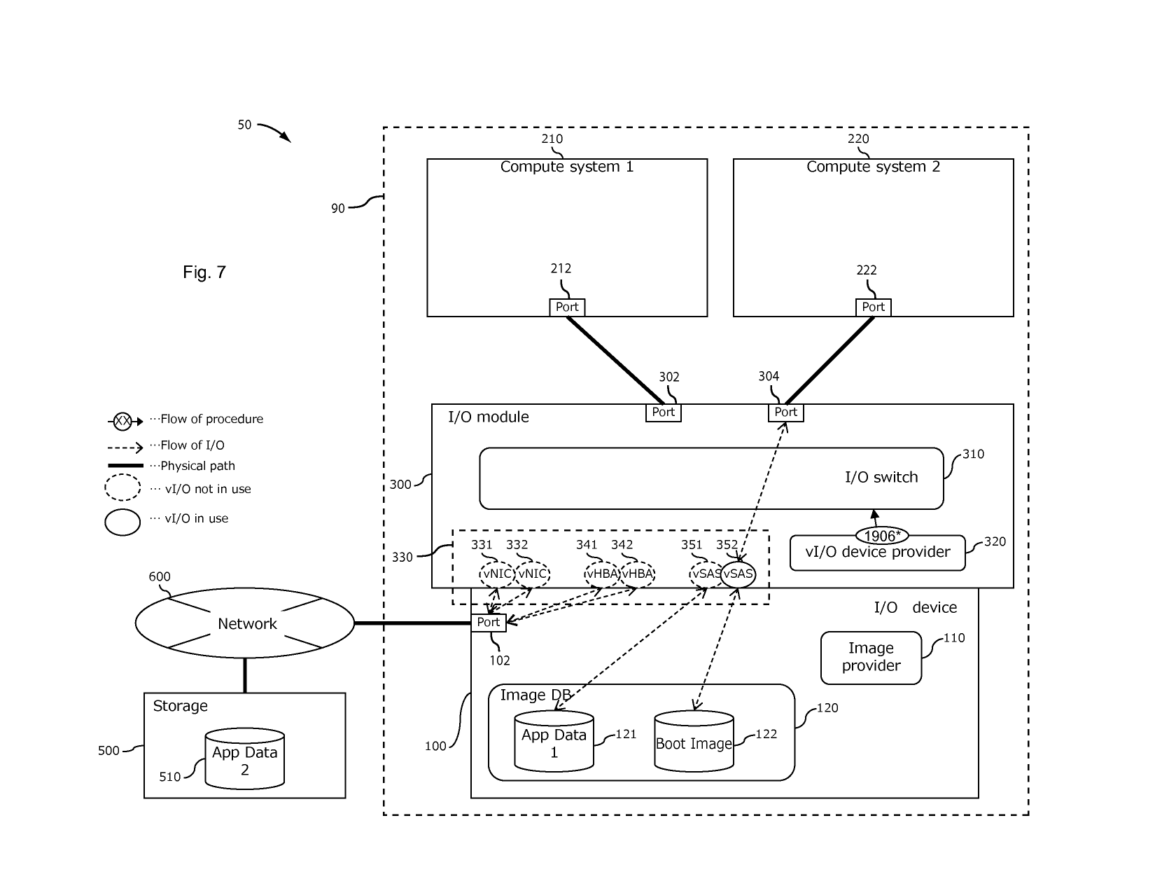

FIG. 5 illustrates an exemplary process 1800 for generating vI/Os in table 1600. At step 1801, a manager module inputs a vI/O preference for a new vI/O to I/O device provider 320. The manager module may be a human being or a management system. When the input is received, I/O device provider 320 creates a vI/O instance on vI/O list table 1600 with a new vI/O ID 1601 (step 1802) and transmits the new vI/O ID 1601 to the manager module (step 1803).

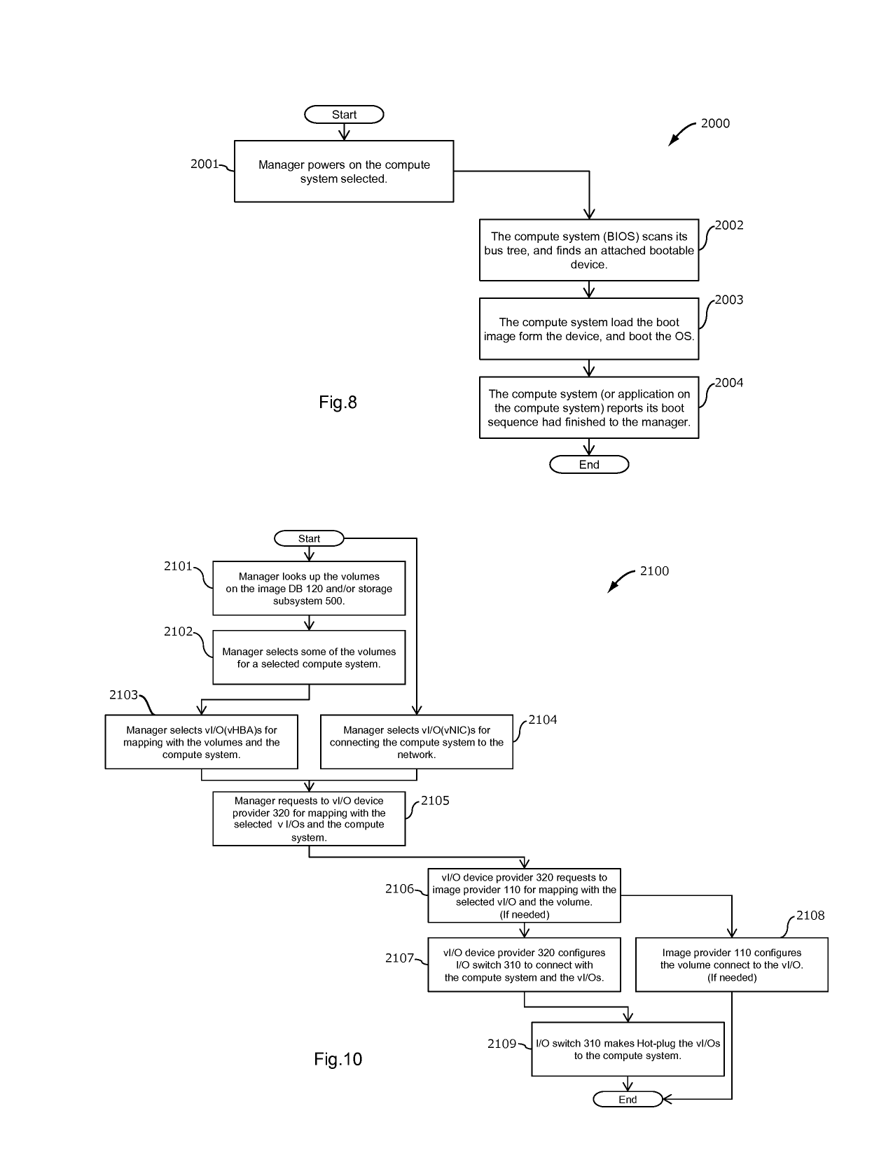

FIG. 6 shows an exemplary process 1900 for vI/O mapping for system boot. Process 1900 may be performed at the time of the system boot or predefined for a subsequent system boot. A manager module maps a boot image to a computer system prior to commencing the booting. The manager module can be a software module or hard coded

At step 1901, a manager module looks up boot images available for host system 90. An example of available boot images is boot image 122 in image database 120 of I/O device 100. Other boot images in other I/O devices (not shown) that are mounted in I/O module 300 are also available to the computer systems in host system 90. The manager module selects a boot image (e.g., boot image 122) from these available boot images (step 1902). The manager module sends a request to vI/O device provider 320 to map the selected boot image to a computer system to be booted (step 1903). For example, the manager module requests boot image 122 to be mapped to computer system 220.

When a mapping request is received, vI/O device provider 320 selects a suitable vI/O to map the selected boot image and the computer system (steps 1904). For example, vI/O device provider 320 selects a vSAS 352 to map boot image 122 to computer system 220.

If the connection between vI/Os and boot images has not been made previously, vI/O device provider 320 sends a request to image provider 110 for mapping with the selected vI/O and the selected boot image (step 1905). Image provider 110 configures the boot image connected to the vI/O by opening the masking (step 1907). Steps 1905 and 1907 are not needed if the connection between the selected vI/O and the selected boot images has been made previously.

At step 1906, vI/O device provider 320 configures I/O switch 310 to connect the selected computer system and the selected vI/O. That is, I/O switch 310 configures port 304 to vSAS 352, so that computer system 220 is able to access boot image 122 via I/O module 330. In an embodiment, I/O switch 310 is a PCI Express switch (PCIeSW), and step 1906 involves a configuration of bus tree of PCIeSWs from down port of root complex to up port of PCI device.

FIG. 7 shows vI/O device provider 320's instructing I/O switch 310 to connect vSAS 352 and port 304 (see numeral 1906*). A connection is provided between vSAS 352 and port 304 accordingly.

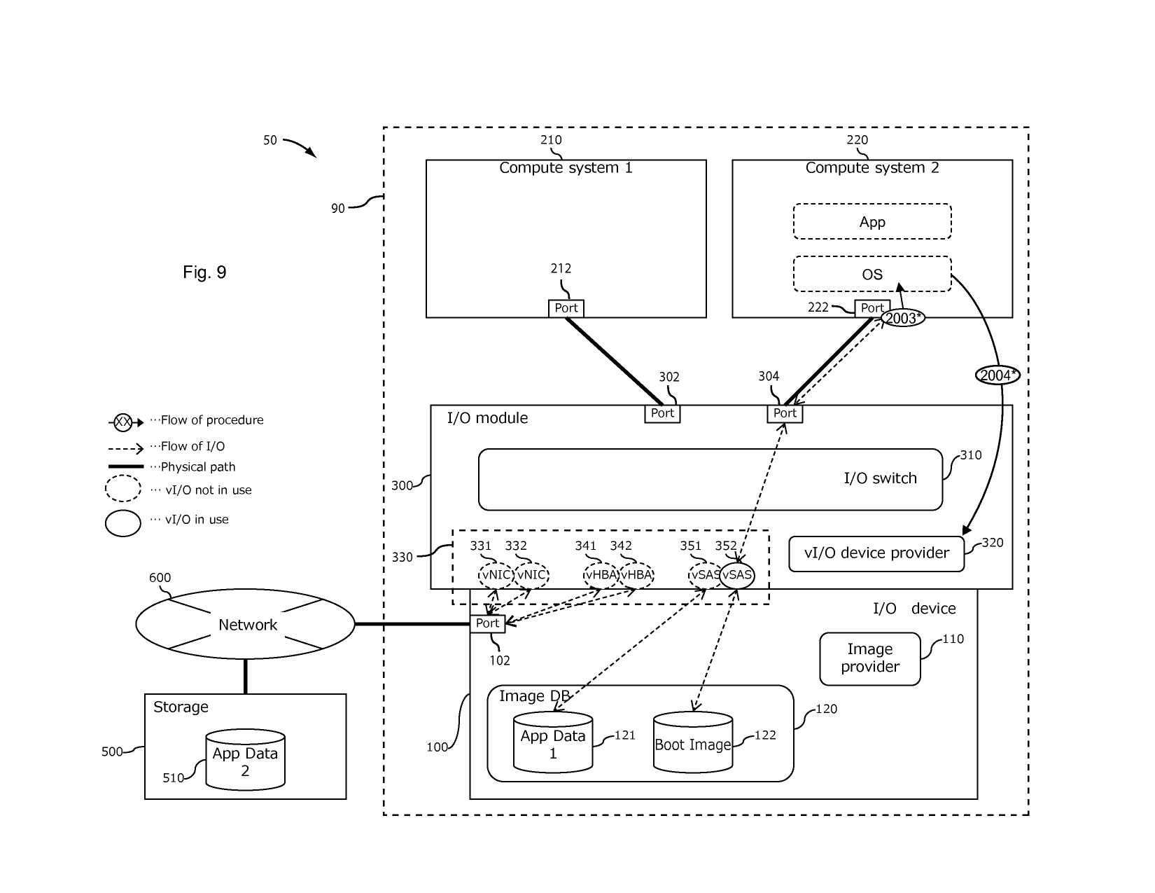

FIG. 8 shows an exemplary process 2000 for performing a system boot. Process 2000 can be performed shortly after the manager module has completed the vI/O mapping as per process 1900, or any time after process 1900 has been completed. At step 2001, a manager module powers on a selected computer system. The computer system scans its bus tree and finds an attached boot image on image database (step 2002). The attached boot image is the boot image that was map to the computer system in process 1900. At step 2003, the computer system loads the boot image and boots the OS (see numeral 2003* in FIG. 9). Once the system boot is completed, the computer system or an application on the computer system reports to the manager module that the boot sequence is finished (step 2004). Numeral 2004* in FIG. 9 illustrates the notification from the computer system to a manager module. In an embodiment, the notification is reported to the manager module via vI/O device provider 320 using the management network or PCI signaling. Accordingly, the manager module would know the computer system is ready to be used. In the conventional process, the manager module had to wait to receive an email from a management system or the like because the notification process was not integrated with the boot process.

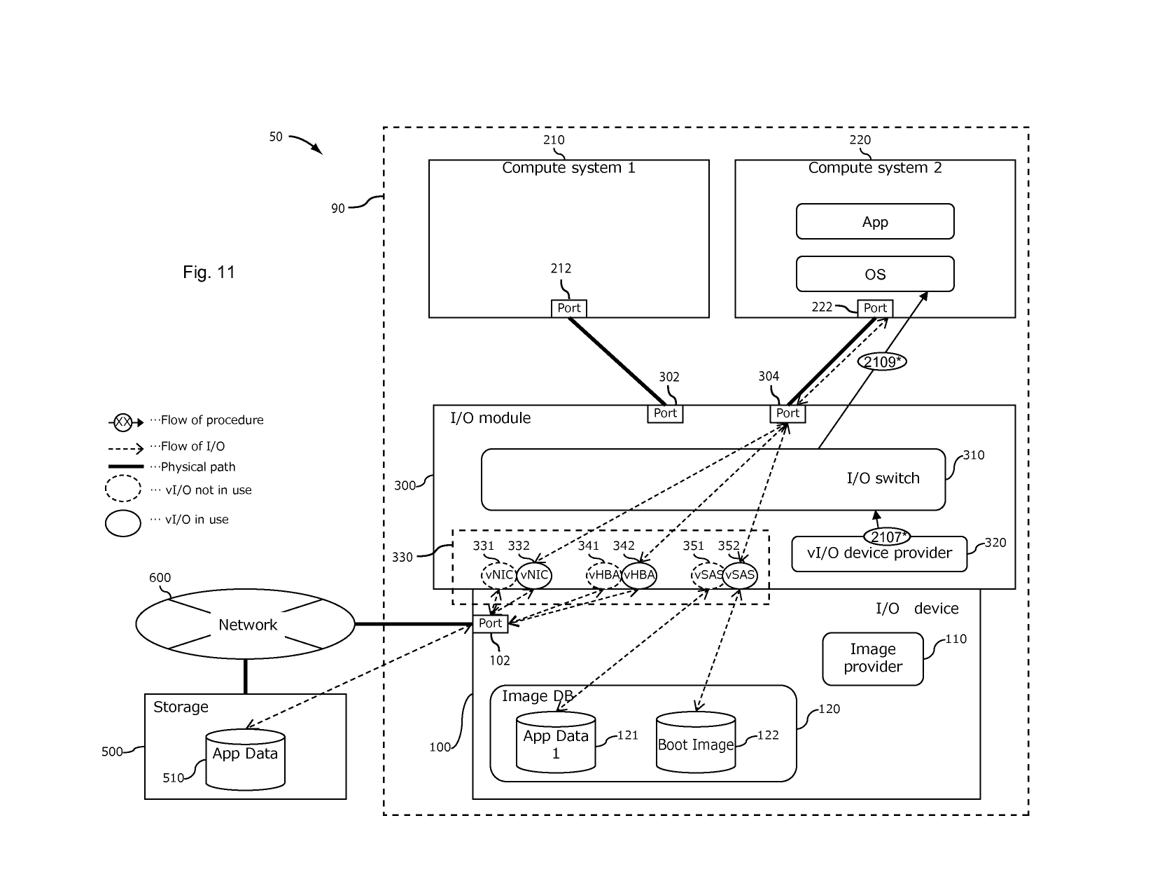

FIG. 10 shows an exemplary process 2100 for vI/O re-mapping to a computer system. After OS booting, a manager module or other systems can attach other storage volumes, storage devices, and/or network adapters to the computer system. In order to attach additional I/Os to the computer system, a manager module looks up volumes in image database 120 and/or volumes in storage subsystem 500 that are available for attachment (step 2101). The manager module selects one or more volumes for a computer system (step 2102). The manager module selects the vI/Os needed for the requested I/Os, e.g., vHBAs (step 2103). The manager module may also select vNICs for connecting the computer system to the network (step 2104). In either scenario, the manager module sends a request to vI/O device provider 320 for mapping the selected vI/Os to the selected computer system (step 2105).

If needed, image provider 110 configures the volume connection as in steps 1905 and 1907 (steps 2106 and 2108). These steps are not needed if the volume connection had been completed previously.

At step 2107, when a request is received, vI/O device provider 320 configures I/O switch 310 to connect with the selected computer system and the selected vI/Os (see numeral 2107* in FIG. 11), which is similar to step 1906. Once the configuration has been completed, I/O switch 310 hot-plugs the new attached vI/Os to the computer system (step 2109), which is illustrated as numeral 2109* in FIG. 11. That is, I/O switch 310 sends an interrupt signal to the OS in computer system 220. The computer system recognizes the new I/O devices and commences using the attached storages and/or networks.

The preceding has been a description of the preferred embodiment of the invention. It will be appreciated that deviations and modifications can be made without departing from the scope of the invention, which is defined by the appended claims.

What is claimed is:

1. A method for node provisioning in a storage system, the method comprising:
providing an I/O module in the storage system having a network and a storage subsystem, the network connecting the I/O module and the storage subsystem, the I/O module being connected to a plurality of computer systems including a first computer system and configured to provide virtualized I/O links to the first computer system;
mapping a first virtual I/O link associated with a first boot image to the first computer system, the first boot image being associated with a first I/O device mounted in the I/O module, and
causing an I/O switch in the I/O module to connect the first virtual I/O link to the first computer system,
wherein the first boot image is suitable for booting the plurality of computer systems connected to the I/O module.

2. The method of claim 1, further comprising:
mapping the first virtual I/O link associated with the first boot image to a second computer system in the plurality of computer systems; and
causing the I/O switch in the I/O module to connect the first virtual I/O link to the second computer system.

3. The method of claim 1, wherein the first boot image is stored in an image database of the first I/O device.

4. The method of claim 1, further comprising:
initiating a boot sequence of the first computer system after the I/O switch connects the first virtual I/O link to the first computer system; and
reporting the completion of the boot sequence by the first computer system.

5. The method of claim 1, further comprising:
providing a plurality of boot images available for the first computer system, the first boot image being part of the plurality of boot images; and
receiving a request to map the first virtual I/O link with the first computer system.

6. The method of claim 5, wherein the request is received by a vI/O device provider of the I/O module, the vI/O device provider being a software module running in the I/O module.

7. The method of claim 6, wherein the first I/O virtual link is a vSAS link managed by the vI/O device provider, the vSAS link providing connectivity to data images in an image database of the first I/O device.

8. The method of claim 5, further comprising:
sending a request to an image provider associated with the first I/O device to open a connection between the first virtual link and the first boot image; and
connecting the first virtual link and the first boot image.

9. The method of claim 1, wherein the first virtual link is a vSAS link managed by a vI/O device provider of the I/O module, the vSAS link providing connectivity to data images in an image database of the first I/O device.

10. An I/O module for providing virtualized I/O links to a plurality of computer systems, the I/O module being connected to a storage subsystem via a network, the I/O module comprising:
a plurality of communication ports for connecting with a plurality of computer systems, the computer systems including a first computer system that is connected to a first communication port;
a first I/O device having an image database and a network port configured to provide a network link to the I/O module, the image database having a first boot image stored therein;
a plurality of virtual I/O links, at least one virtual link for connecting to the network and at least one for connecting to the image database of the first I/O device;
an I/O switch configured to connect the virtual I/O links to the first computer system; and
a vI/O device provider configured to communicate with the I/O switch, the I/O device provider being configured to:
receive a request to map a first virtual I/O link associated with the first boot image to the first computer system,
map the first virtual I/O link associated with the first boot image to the first computer system, and
cause an I/O switch to connect the first virtual I/O link to the first computer system.

11. The I/O module of claim 10, the vI/O device provider is further configured to:
map the first virtual I/O link associated with the first boot image to a second computer system in the plurality of computer system; and
cause the I/O switch to connect the first virtual I/O link to the second computer system.

12. The I/O module of claim 10, the I/O module is configured to:
provide a plurality of boot images available for the first computer system, the first boot image being part of the plurality of boot images, wherein a request in order to map the first virtual I/O link with the first computer system is sent to the vI/O device provider.

13. The I/O module of claim 10, wherein the first virtual link is a vSAS link, the vSAS link providing connectivity to data images in an image database of the first I/O device.

14. The I/O module of claim 10, further comprising:
a second I/O device having an image database and a network port configured to provide a network link to the I/O module, the image database of the second I/O device having a second boot image stored therein,
wherein the I/O module is configured to provide the first and second boot images as being available for the first computer system.

15. A storage system comprising:
a storage subsystem;
a network;
an I/O module connected to the storage subsystem via the network, the I/O module configured to provide virtualized I/O links to a plurality of computer systems, the I/O module comprising:
a plurality of communication ports for connecting with a plurality of computer systems, the computer systems including a first computer system that is connected to a first communication port;
a first I/O device having an image database and a network port configured to provide a network link to the I/O module, the image database having a first boot image stored therein;
a plurality of virtual I/O links, at least one virtual link for connecting to the network and at least one for connecting to the image database of the first I/O device;
an I/O switch configured to connect the virtual I/O links to the first computer system; and
a vI/O device provider configured to communicate with the I/O switch, the I/O device provider being configured to:
receive a request to map a first virtual I/O link associated with the first boot image to the first computer system,
map the first virtual I/O link associated with the first boot image to the first computer system, and
cause an I/O switch to connect the first virtual I/O link to the first computer system.

16. The storage system of claim 15, the vI/O device provider is further configured to:
map the first virtual I/O link associated with the first boot image to a second computer system in the plurality of computer systems; and
cause the I/O switch to connect the first virtual I/O link to the second computer system.

17. The storage system of claim 15, wherein the first virtual link is a vSAS link.

18. The storage system of claim 15, wherein I/O module of claim 10 further comprises:
a second I/O device having an image database and a network port configured to provide a network link to the I/O module, the image database of the second I/O device having a second boot image stored therein,
wherein the I/O module is configured to provide the first and second boot images as being available for the first computer system.
